(19) United States
(12) Patent Application Publication
(10) Pub. No.: US 2016/0334264 A1
(43) Pub. Date: Nov. 17, 2016

(54) Apparatus and Method for Conveying Flowable Materials, In Particular Bulk Materials

(71) Applicant: ALFONS TSCHRITTER GMBH, Dorfprozelten (DE)

(72) Inventor: Thorsten Tschritter, Stadtprozelten (DE)

(21) Appl. No.: 15/112,485

(22) PCT Filed: Jan. 20, 2015
(86) PCT No.: PCT/EP2015/051005

§ 371 Date: Jul. 19, 2016

(30) Foreign Application Priority Data
Jan. 20, 2014 (DE) 10 2014 200 924.3

(51) Int. Cl. G01F 23/296; G01F 23/284; G01F 23/292; B65G 53/16

(52) U.S. Cl. CPC G01F 23/2962; B65G 53/16; G01F 23/284; G01F 23/292; B65G 2201/04

(57) ABSTRACT

An apparatus for the conveyance of at least one flowable material, in particular of bulk materials, is provided. The apparatus includes at least one first container for taking up the flowable material, wherein the at least one first container includes at least one first inlet means for introducing the flowable material into the first container and at least one outlet means for discharging the flowable material from the first container. The at least one first container includes at least one means for the contactless measurement of the quantity of the flowable material in the at least one first container.

The present invention relates to an apparatus for conveying at least one flowable material with the features of the preamble of claim 1, a method for conveying at least one flowable material with the features of claim 14, and the use of a measuring means with the features of claim 19.

### DESCRIPTION

In many applications it is necessary to dose bulk materials from a material reservoir. For example, in the plastics processing industry bulk materials, for example in the form of virgin granules and grinding material from recycling mills, must be transported to processing machines or driers which are arranged on the processing machines. For conveying the bulk materials various types of apparatus are known. There can either be used turbine conveyors with AC turbines or suction conveying systems, which consist of a vacuum generator with three-phase drive and a separate conveying separator.

Furthermore, a pneumatic conveying system is known, in which a suction lance is put into the bulk material stock to be conveyed and compressed air is introduced into the suction lance, which within the suction lance is redirected in conveying direction and thereby generates a suction effect (see DE 26 59 058).

Especially in the plastics processing industry it often also is required that not only one type of material, but two or more types at the same time or one after the other are supplied to the plastics processing machine. This is the case, for example, when virgin material and grinding material from a press-side granulator are to be supplied in a defined percentage ratio on a processing machine.

Conveying separators for suction conveying plants typically consist of a separator and a recipient tank provided below the separator, from which the bulk material is supplied to the corresponding processing machine, such as an extrusion machine.

The pneumatic suction conveyance of bulk materials, preferably plastic granules or grinding materials, by using such conveying separators is triggered by digital signals, i.e. both the start and the end of the conveying operation are determined by digital signals.

It is known, for example, to trigger the start of conveyance by scanning a fixed material level below the separator in the recipient tank, for example by capacitive proximity switches or by a mechanical flap, for example a pendulum flap. The pneumatic suction conveyance conventionally is started by the use of a conveying blower (suction blower) and the conveying air flow generated by the conveying blower is supplied to the separator through a conveying valve, so that bulk material is sucked in via a material inlet provided at the separator. When the conveyance is to be switched off, the conveying valve is closed for the conveying air flow and the conveying air flow can be supplied to a further separator as suction air.

The conveying separators known from the prior art have various disadvantages. In the known conveying separators it is necessary, on the one hand, to fix the switching level in advance during the construction of the conveying separator, so that a change is not possible in ongoing operation. As described above, the material level or the material quantity in and below the separator in addition is determined by means of scanning methods, which especially in the case of electrostatically chargeable materials can lead to a failure of the sensors.

The use of a mechanical pendulum flap for controlling the transported quantity of bulk material also can be problematic, as here material deposits can occur at the flap, which change the center of gravity of the pendulum flap, which likewise can result in a malfunction and lead to the failure of the conveyance. In addition, conveying flaps require a readjustment of the conveying flap in particular with fluctuating bulk densities of the conveyed materials, as the flap otherwise possibly does not open and no start of conveyance is triggered, although the material level or the material quantity has decreased already below the separator.

In the conveying separators known from the prior art, the end of the ongoing conveying operation chiefly is initiated by the elapse of a preset conveying time. When the length of the conveying path changes, for example by coupling over to another material source, or when the pressure resistance of the filter in the conveying separator changes, conveying either takes too long and the separator is overfilled, or the suction path is too short and the processing machine to be supplied runs idle. The manual input of the conveying time also represents a possible source of errors.

It therefore is desirable to limit the manual influence as far as possible, in order to avoid incorrect settings. However, when for example the known capacitive detectors or measuring means in the separator and/or recipient tank are used for switching off the conveyance, the position thereof must be fixed already during the construction of the conveying separator, whereby the use is greatly limited.

Therefore, it is the object underlying the present invention to provide an apparatus for conveying flowable materials, such as bulk materials, which avoids the above-described disadvantages and ensures a continuous and reliable conveyance of bulk materials into the desired processing plant or processing device.

This object is solved with an apparatus with the features of claim 1, a method with the features of claim 12, and the use of a measuring means with the features of claim 17.

Correspondingly, there is provided an apparatus for the conveyance, in particular a suction conveying apparatus, of at least one flowable material, in particular of flowable solids such as bulk materials, which comprises at least one first container for taking up the flowable material, wherein the at least one first container, which for example is present in the form of a separator, includes at least one first inlet means for introducing the flowable material into the first container and at least one outlet means for discharging the flowable material from the first container.

In the case of a suction conveying apparatus, a mixture of air and bulk material is sucked in by negative pressure.

The at least one first container of the present apparatus according to the invention furthermore comprises at least one means for the contactless measurement of the quantity of the flowable material in the at least one first container. Quantity in the sense of the present invention preferably is understood to be the volume of the flowable material, e.g. in the form of the bulk material. Accordingly, in particular the filling volume in the container is determined.

Due to the contactless measurement of the quantity of the flowable material in the first container it now is possible to use analog measuring methods for scanning the bulk material quantity in the container both for the start of conveyance and for the end of conveyance or only for one of these two processes. In other words, by using a means for the contactless measurement of the quantity of the flowable material in the container a control signal can be transmitted to the inlet means for introducing the flowable material into the container and/or a signal can be transmitted to the outlet means for discharging the flowable material from the first container, wherein a contact of the measuring means by the bulk material is prevented.

As will yet be explained below, the measuring means for the contactless or non-contact measurement of the bulk material quantity in the first container preferably is arranged in an upper portion of the first container, so that, as used to be the case, the position of the measuring means in the side wall of the separator need not be fixed already during the construction.

Suitable measuring means for the contactless or non-contact measurement of the bulk material quantity are formed, as will likewise be explained in detail below, in the form of echo sounding ultrasonic sensors, infrared sensors or also radar sensors.

As described, the apparatus according to the invention serves the conveyance of at least one flowable material, which in particular can be present in the form of bulk material. Bulk material here refers to any mixture which is present in a pourable form. The bulk material for example can be plastic granules, lime, wood particles, fertilizer, feedstuffs, tablets, foodstuffs, in particular cereals, construction materials, raw materials or any other bulk material or an arbitrary mixture of various bulk materials. The particle size of the bulk material, i.e. its grain size or unit size, here can vary in dependence on the kind of bulk material. The present apparatus preferably serves the conveyance of bulk material particles with a mean diameter between 0.5 and 2 mm, which also can be oblong with mean lengths between 1 and 3 mm. In general, it is also possible to convey bulk materials with distinctly different particle sizes, such as for example bulk material in powder form or in distinctly larger dimensions. In particular, the present conveying apparatus is used for conveying plastic granule particles which are used in injection molding methods.

In one embodiment of the present apparatus, at least one further second container, e.g. in the form of a recipient tank, is arranged below the first container, wherein the flowable material can be introduced from the first container into the second container. The arrangement of the second container below the first container, i.e. the arrangement e.g. of a recipient tank below a separator, means that both containers are arranged along a common vertical axis. This vertical arrangement of the two containers one above the other provides for an easy introduction of the flowable material from the separator as first container into the recipient tank as second container.

First container and second container preferably are connected via the at least one outlet means for draining the flowable material (bulk material) from the first container into the second container. The outlet means can be formed e.g. in the form of an opening which is provided in a lower portion of the first container. Correspondingly, the present arrangement provides for draining the bulk material from the first container through the opening provided e.g. in the bottom of the first container into the second container (recipient tank) arranged thereunder, wherein the flowable material, e.g. bulk material from the recipient tank, in turn can be discharged to a suitable processing machine, such as an extrusion machine.

In a further preferred embodiment the second container likewise comprises at least one means for the contactless measurement of the quantity of the flowable material in the at least one second container. Corresponding to this embodiment, at least two means for the contactless measurement of the quantity of the flowable material thus are provided in the present apparatus, wherein one measuring means is arranged in the first container e.g. in the form of a separator, and a second measuring means is arranged in the second container, e.g. in the form of a recipient tank.

However, it also is possible and provided that the first and the second container are combined in one single container. Correspondingly, after input into the conveying device the flowable material can directly be supplied to the further processing, e.g. to an extrusion machine. In this case, merely one contactless measuring means, e.g. ultrasonic sensor, is required. This embodiment in particular is advantageous when the processing machine allows the application of a negative pressure.

The at least one means for the contactless or contact-free measurement of the quantity of the flowable material in the first and/or second container preferably emits sound waves. Preferred measuring means for the contactless measurement of a material quantity include ultrasonic sensors, light sensors, IR sensors and/or radar sensors.

As already indicated above, the at least one means for the contactless measurement of the quantity of the flowable material (bulk material quantity) in the first and/or second container each is arranged in an upper region (i.e. as seen in vertical direction in conveying direction of the flowable material) of the first and/or second container, so that the sound waves each from above impinge on the flowable material (bulk material) present in the first and/or second container.

The measuring means in the first container can be provided e.g. at or in the ceiling or above end of the first container. The measuring means in the first container can e.g. firmly be mounted in the ceiling or can also be movably mounted on the container inner side of the container ceiling. The exact placement of the measuring means in the upper portion of the first container is not essential, as long as the first measuring means emits the sound waves vertically downwards into the first container, so that the same cover the interior space of the first container.

The measuring means in the second container likewise can be placed arbitrarily in the upper portion of the second container. The measuring means in the second container can be arranged adjacent to the outlet means of the first container for draining the bulk material from the first container into the second container. Here as well it is essential that the second measuring means sends the sound waves vertically downwards into the interior space of the second container.

The sound waves emitted by the measuring means thus scan the respective container interior space and dependent on the height and thus quantity of the bulk material present in the respective container a signal is received, on the basis of which the bulk material quantity in the respective container can be inferred.

In a preferred embodiment of the present apparatus an ultrasonic sensor, e.g. in the form of an echo sounding ultrasonic sensor, is used as suitable measuring means.

In one embodiment, the ultrasonic sensor used here can be provided with separate transmitting and receiving devices. Correspondingly, the ultrasonic waves in this sensor variant are emitted by the transmitting device, and the reflected ultrasonic waves are detected by the receiving device.

In another embodiment of an ultrasonic sensor used here, the transmitting and receiving devices are not separate from each other. Rather, the transmitting device is switched over after sending the sound signal and utilized as receiving device. The advantage of this embodiment of the ultrasonic sensor consists in that the same is easier to install and to seal.

In the choice of a suitable ultrasonic sensor care should be taken that the measurement range covers the volume to be monitored in the conveying apparatus. Advantageously, reception ranges of 2 to 200 cm, preferably 10 to 100 cm, are utilized here.

When using ultrasonic sensors, care should preferably be taken that the sound signal supplied is filtered. Filtering primarily is due to the fact that during the conveying process of the bulk material the bulk material particles in the first container are not static, but rather are subject to a movement (e.g. jumping around). This particle movement can lead to a distortion of the signal and thus to a distortion of the indication of quantity in the container. Correspondingly, the ultrasonic sensor used here comprises a relatively insensitive filter for measuring the material level or material quantity in the container and a further filter for detecting the inflowing bulk material into the container.

It likewise is imaginable and provided that in the second container (recipient tank) mixing devices are incorporated, such as for example a revolving paddle. However, the transmitted sound waves can be reflected by the mixing device. To here avoid a distortion of the signal and hence of the determined bulk material quantity, it preferably is provided that the movement of the mixing device such as e.g. a rotating paddle is detected and evaluated by cyclic reflection during a continuous rotation. The cyclically determined signal can be filtered out correspondingly, in order to determine the material quantity of the bulk material in particular in the recipient tank.

The principle of the ultrasonic measurement is known per se and here will be outlined only briefly with respect to the present apparatus. The respective ultrasonic sensor emits a sound signal (ultrasound with a wavelength between 50 and 200 kHz) into the respective container or space (separator or recipient tank). As described already, the ultrasonic sensors here each are arranged at the upper end of the separator and/or recipient tank, so that the ultrasonic waves are emitted downwards into the respective container interior space and reflected by the flowable material (bulk material) each present in the container interior space. The reflected sound waves are received by the sensor or a sound transducer connected therewith. From the travel time of the reflected ultrasonic waves, the distance between sensor and bulk material and thus the height and the filling level of the bulk material in the respective container is determined.

The contactless measurement, such as in the form of an ultrasonic measurement, as compared to the capacitive or inductive measurements, offers the possibility for saving energy. Capacitive and inductive sensors generally are permanently supplied with power and thus permanently consume energy. Switching off the power supply to capacitive and inductive sensors however means an increased control expenditure and hence also increased costs. During the contactless measurement, for example by ultrasound, no power is consumed between the measuring pulses or measuring waves (emitting the measuring wave and waiting for reflection). Depending on the measured conveying throughput of the present apparatus, the measuring interval now can additionally be prolonged to a maximum value, without influencing the security of supply of the processing machine.

In a further embodiment of the present apparatus the outlet means provided in the lower portion of the first container for introducing the material, for example bulk material, from the first container into the second container is formed frustoconical. The wide end of the outlet means thus points in direction of the material and gas inlet, i.e. in direction of the first container, and the narrow end of the outlet means points in direction of the second container. The frustoconical structure of the outlet means divides the apparatus into a separation volume (volume in the first container) and a recipient tank volume (volume of the second container). The outlet means for example can be constructed of plates, wherein the plates of the frustoconical structure are arranged inclined with respect to a plane which is perpendicular to the longitudinally directed axis of the container. The angle of inclination of the plates of the outlet means can amount to between 30 and 90 degrees, preferably 60 to 90 degrees. In a particularly preferred embodiment, a cone with an opening angle of 60° to 90° correspondingly is used as outlet means.

In another variant of the present apparatus a control means for controlling the quantity of flowable material to be introduced from the first container into the second container is provided at or adjacent to the outlet means. The control means for example can be formed in the form of a flap, such as a mechanical pendulum flap. In dependence on the bulk material quantity to be conveyed, which is determined by the contactless measurement of the bulk material quantity in the first and/or second container, an adjustment of the pendulum flap is made for the targeted control of the mass flow of the flowable material (bulk material) from the first container into the second container. The use of a shut-off valve instead of a flap, such as a pendulum flap, also would be possible.

It furthermore is preferred when the present apparatus is connected with a plant for the further processing of the flowable material. The processing plant preferably is arranged below the second container of the apparatus or extends below the second container. It is imaginable for example that below the second container a transport belt extends, which serves for filling transport containers. Another variant of a processing plant for example is an extrusion device for melt processing in the production of plastics.

As already indicated above, the present object also is solved by a method for conveying at least one flowable material, which is carried out in the apparatus according to the invention. Correspondingly, the present conveying method comprises the steps of introducing the flowable material via at least one inlet means into the first container, and determining the quantity of the flowable material in the first container by using a first means provided in the first container for the contactless measurement of the quantity or the filling level of the flowable material in the first container, wherein in dependence on the quantity of the flowable material determined in the first container the mass flow of the flowable material in or through the first container is controlled.

The introduction of the flowable material into the first container through the first inlet means preferably is effected and adjusted by introducing at least one air flow through the at least one second inlet means. Preferably, the air flow is generated by at least one conveying blower. By introducing the air flow into the present apparatus, the flowable material is sucked in through the first inlet means into the first container of the present apparatus.

The flowable material present in the first container is drained from the first container through an outlet means into a second container arranged below the first container. This step of draining can be adjusted or controlled by a control means provided at the outlet means, for example in the form of a mechanical pendulum flap. The pendulum flap preferably opens automatically, as soon as the conveying valve switches off. The bulk material conveyed then drops through the outlet means (e.g. lower opening) into the second container.

Preferably, the quantity of the flowable material in the second container is determined by using a second means provided in the second container for the contactless measurement of the quantity or the filling level of the flowable material, wherein the mass flow of the flowable material from the second container, for example in a processing plant, is adjustable in dependence on the quantity of the flowable material determined in the second container.

Correspondingly, the flowable material can be guided from the second container of the present apparatus to a plant for the further processing of the flowable material. Such processing plant for example can be an extrusion device for processing plastic granules or the like.

In one embodiment of the present method the delivery rate of the flowable material lies in a range between 100 kg/h and 2,000 kg/h, preferably between 400 kg/h and 600 kg/h. The conveying air flow rate preferably is 150 to 250 m³/h, in particular 200 m³/h. At these flow rates, there are preferably used separators (here first container) with a volume between 20 and 200 liters, preferably 50 to 150 liters, so that the measuring heights of the contactless measuring means (such as ultrasonic sensors) vary in a range of 20-200 cm.

The use of a non-contact or contactless measuring means, e.g. in the form of contactless sensors like the above-described ultrasonic sensors for measuring the quantity of a flowable material (bulk material) in the present conveying device for flowable materials has various advantages.

When using a contactless sensor like an ultrasonic sensor in the first container, e.g. in the form of a separator, a maximum conveying level can be set. This eliminates the need for inputting a conveying time. In addition, the contactless measurement of the bulk material quantity can be effected during the actual conveying operation, so that a measurement is not effected in the waiting times, while e.g. other separators convey the bulk material or no material is conveyed at all. During longer idle or waiting times, the measurement interval of the contactless measurements also can be increased, in order to minimize the energy consumption. In practice it frequently occurs that the actual processing machines, e.g. extrusion machines, are stopped, but the conveyance remains switched on. The use of a contactless sensor system can effect a dynamic adaptation of the measurement intervals, so that only so much energy is consumed for the measuring means as is absolutely required for operating the plant. This is an advantage over the conventional sensor system, which is switched on at any time and thus consumes energy at any time.

Another advantage of the use of a contactless sensor in a separator consists in that at each quantity or level measurement of the bulk material in the separator the quantity conveyed can be calculated and accounted for with a knowledge of the separator geometry and the bulk weight of the conveyed material. During the ongoing conveyance, a mass flow (kg/h) can be determined from the difference of the measured filling levels, which can serve a further examination and inspection of the conveying apparatus. When e.g. the mass flow suddenly stops or is greatly reduced, it can be concluded therefrom that the material source is empty or the conveyance has been interrupted, e.g. by inadvertent coupling over. When the mass flow on the other hand for example is subject to great fluctuations, a plug formation during the conveyance can be inferred. It also is possible to compare the mean value of the mass flow with the mean value of the mass flow from the preceding conveying operations or conveying processes. In the case of a permanent strong deviation it might be concluded that another material or another material source has been chosen.

Another essential advantage of the present apparatus consists in that by measuring the mass flow or by varying the quantity level in the separator as first container a fault evaluation already is possible during the conveying operation and thus an early intervention of the operating personnel can be effected in the case of faults. This provides for lowering the material receivers, so that material and time are saved. In the case of the conventional methods, a determination of a conveying disruption merely is possible by the opening time of the conveying flap or the probe signal below the separator, i.e. always after termination of the conveying operation. This leads to long conveying or suction times in which no material is conveyed or sucked. Other separators of the same plant might run idle in this unused conveying time. The present contactless measurement of the filling level in the present apparatus on the other hand solves this problem in an advantageous way.

Another advantage of the present apparatus using a contactless measuring means consists in that the ongoing conveying operation can be terminated as soon as a requested production quantity has arrived. The present apparatus thereby can minimize material losses towards the end of the production job.

In addition, an optimum mass flow can be predetermined for the different materials, in order to avoid a formation of dust and angel hair, to reduce abrasive wear or to protect the apparatus as far as possible. Corresponding to the desired mass flow, negative pressure and conveying volume are adjusted or measured and controlled. It even is possible to reduce the air velocity of the conveying stream to such an extent that the conveyance changes from a strand conveyance into the unstable area, in which plugs are produced in the conveying line to an increased extent. The conveying plant thus can adjust itself to an optimum conveying speed. This likewise saves energy and is gentle on the material.

The use of a contactless measuring means, such as for example an ultrasonic sensor for determining the quantity level of a flowable material in the second container, for example in the form of a recipient tank below the first separation tank, provides a measurement signal which indicates the material height or material quantity in the second container below the separator. The switching level here is determined by the control logic and no longer by the mechanical installation, which likewise involves some advantages.

The contactless measurement is advantageous especially in abrasive conveying goods such as glass-fiber reinforced plastics, in particular as a failure of otherwise usual contact sensors is avoided. In addition, the mass determination of conveying goods or bulk goods which only allow contact to stainless steel, such as in medicine or in the food industry, also can become possible. In other words, the contact-free measuring means used here thus can now be used in conveying separators which selectively convey goods for medicine or the food industry.

The switching level is independent of the bulk weight and the electrostatic properties of the flowable material. The switching level can be determined by the control logic. For example, switching can be effected between various switching levels, depending on whether the processing machine to be supplied is in ongoing operation or in a retooling or idling phase. The material supply of the processing machine via the conveying device thereby can be adjusted such that towards the end of the production job no more material is present in the material receiver. This saves material and retooling time.

Moreover, it now is possible to switch the machine over to another bulk material in ongoing operation, without stopping. The quantity level of the bulk material in the recipient tank here is allowed to decrease to a lower quantity level, the material source subsequently is switched over and the conveyance is again started immediately. The decrease of the quantity level in the recipient tank as second container of the present apparatus here is effected down to closely above the processing machine, so that upon filling with a new bulk material no mixing of the bulk materials occurs. A change of material thereby is possible in ongoing operation and without stoppage of the processing machine. This likewise saves retooling times and material.

The quantity level of the flowable material in the apparatus or the switching level in the second container in the form of the recipient tank also can be used for determining a conveying priority. In conveying plants with several separators the blower then preferably is allocated to that separator which possibly might run idle next. The lower the quantity level and the higher the throughput of the machine, the higher the allocation priority. In urgent cases, the ongoing conveying operation of another separator even can be interrupted, in order to start the separator with the higher priority. The measured quantity level or bulk material level also can be used to measure the throughput of the processing machine filled with the conveyed bulk material.

It likewise is possible to determine the quantity of the bulk material in the recipient tank. Depending on the quantity yet to be produced in the processing machine it can then be decided whether or not a new start of conveyance is to be effected.

During the conveying operation it can also be checked whether the bulk material level has fallen below a critical level. In this case, the ongoing conveying operation is interrupted and the separator is drained, in order to prevent idling of the processing machine.

After the end of the conveying operation, the conveyed bulk material can be drained into the recipient tank. When using the contactless measuring method, such as for example an ultrasonic measuring method, the drained bulk material quantity can be calculated with a knowledge of the geometry of the recipient tank. When the conveyed bulk material quantity deviates too much from the expected bulk material quantity, a disruption of the conveying operation can be inferred and a corresponding alarm can be triggered.

The invention will be explained in detail below by means of an exemplary embodiment with reference to the Figures of the drawing, in which:

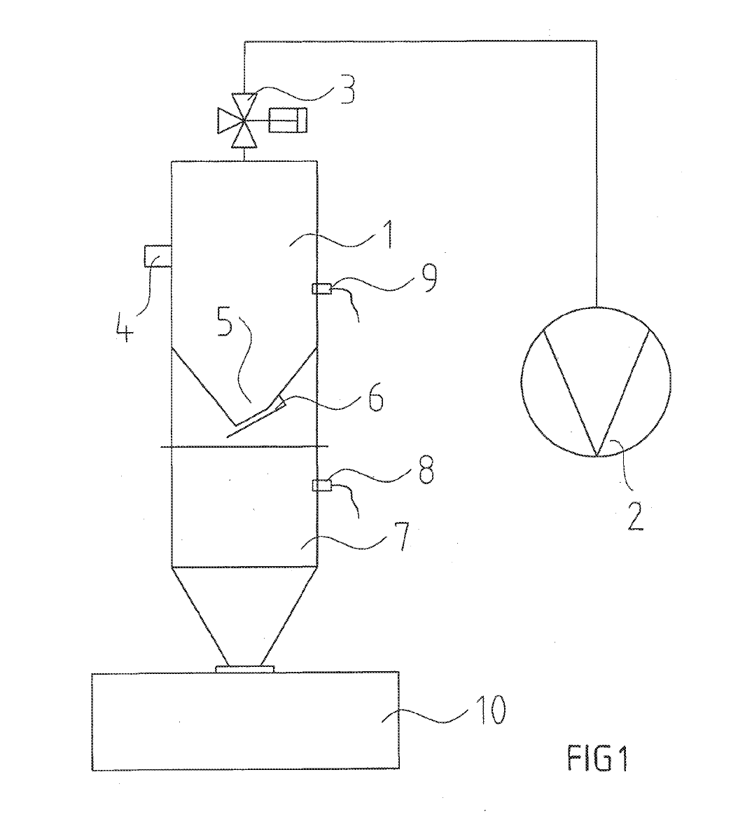

FIG. 1 shows a schematic representation of a conveying separator with conventional measuring means for determining the filling level,

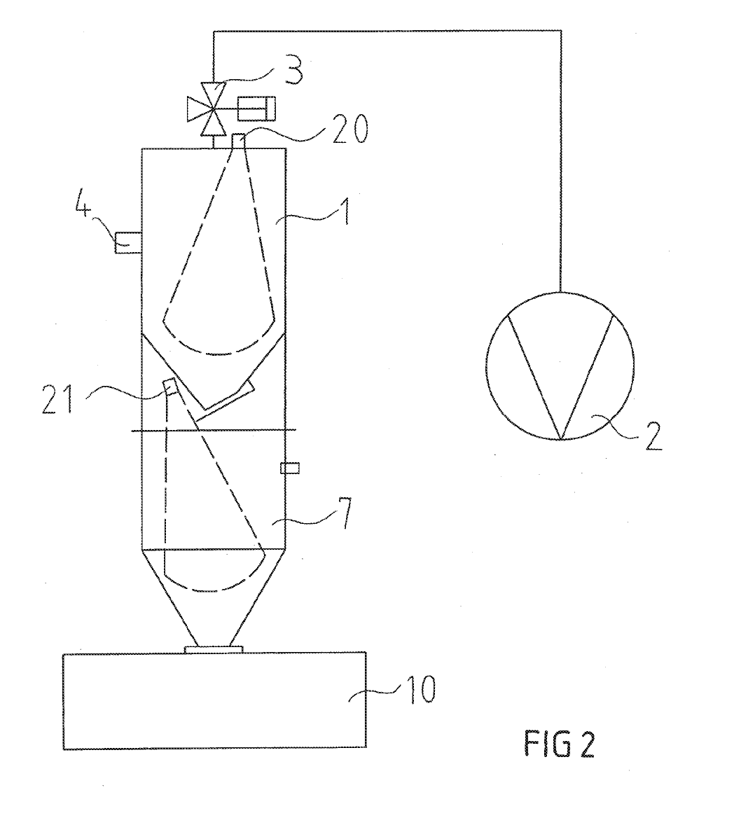

FIG. 2 shows a schematic representation of a conveying separator according to a first embodiment of the present invention, and

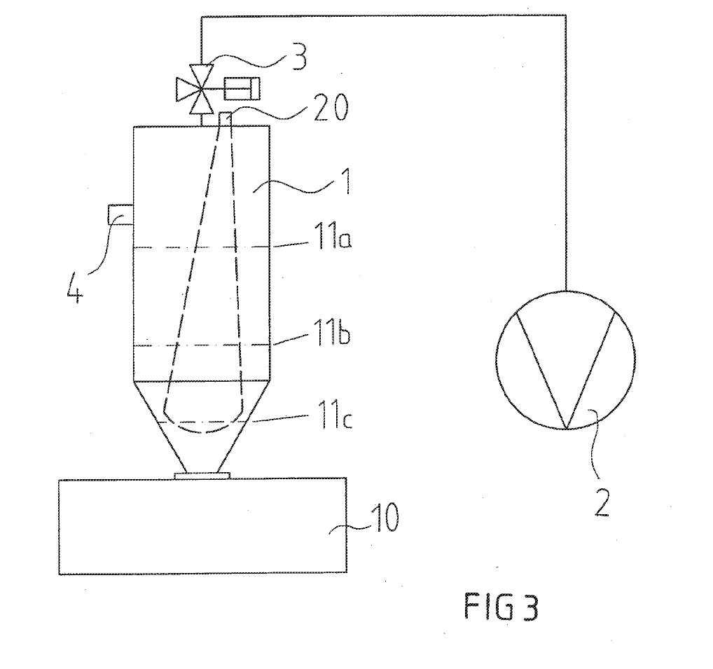

FIG. 3 shows a schematic representation of a conveying separator according to a second embodiment of the present invention;

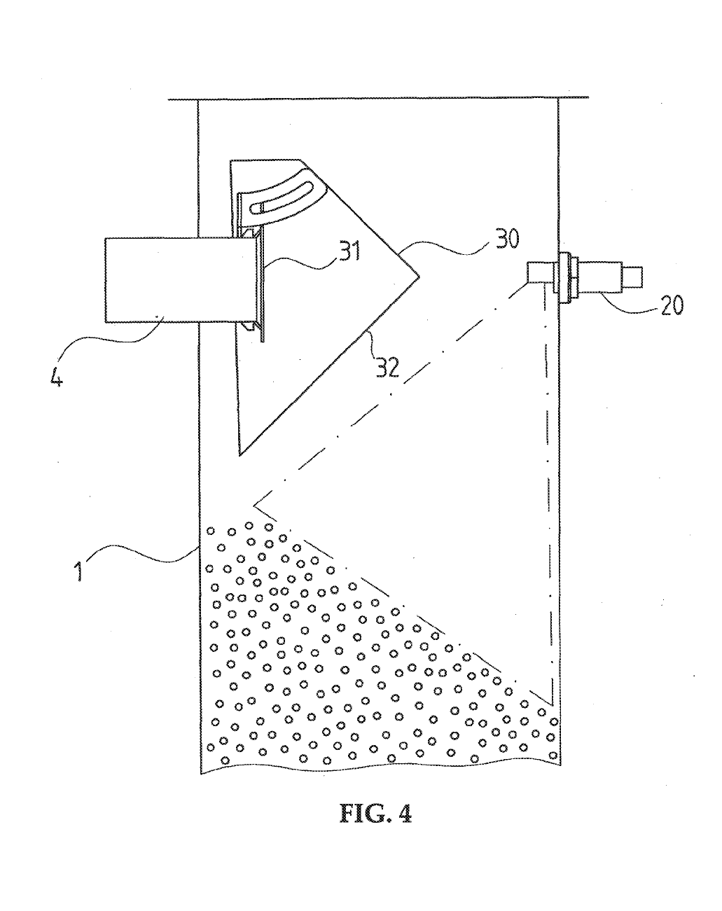

FIG. 4 shows a schematic representation of a third embodiment with a material level detection with quiescent conveyance;

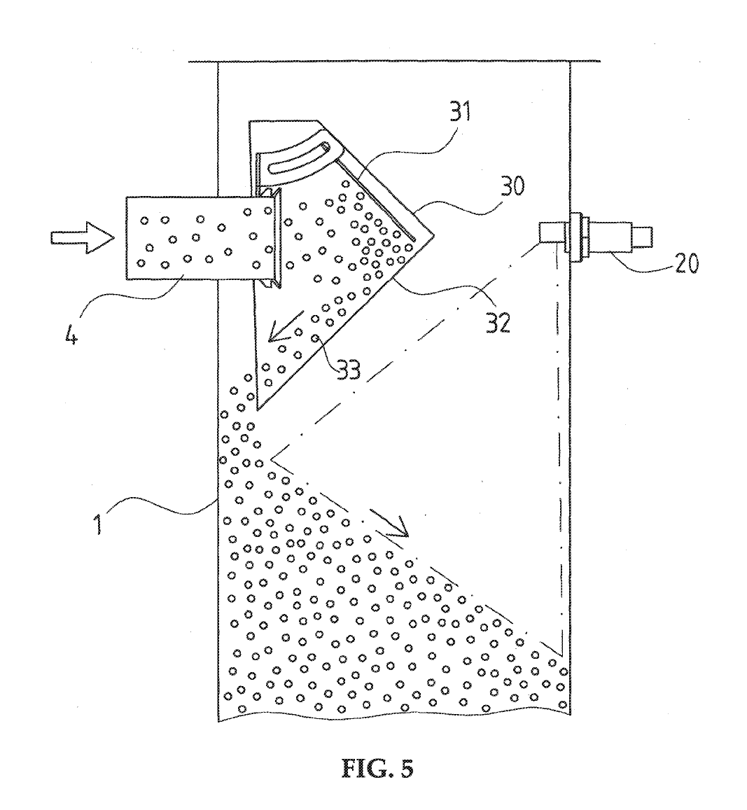

FIG. 5 shows a schematic representation of the material level detection in the third embodiment with ongoing conveyance;

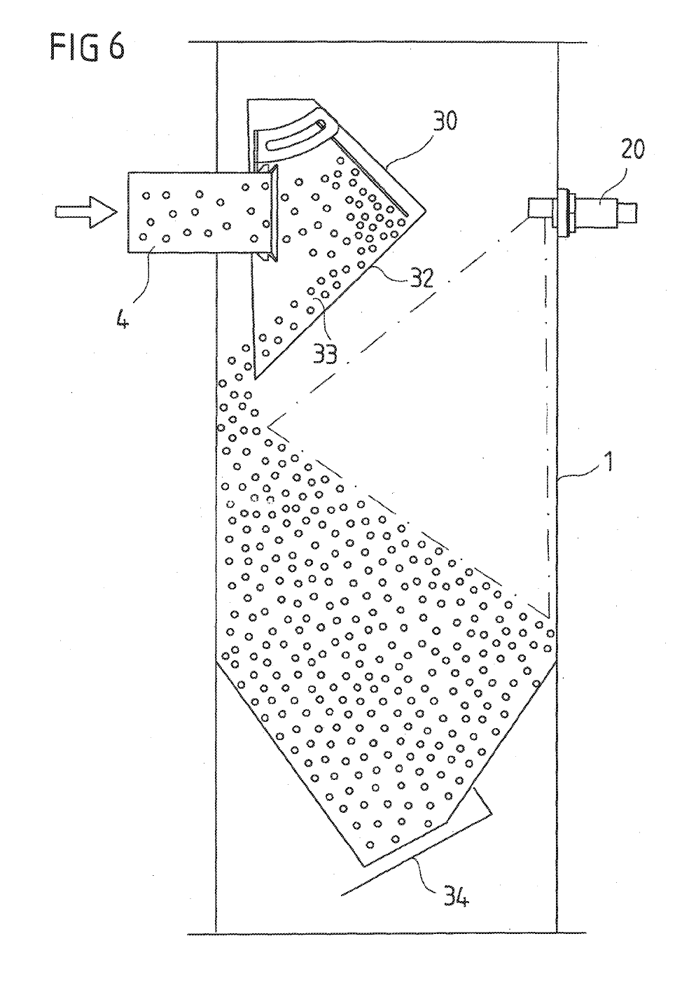

FIG. 6 shows a fourth embodiment with a particular configuration of the lower conveying region;

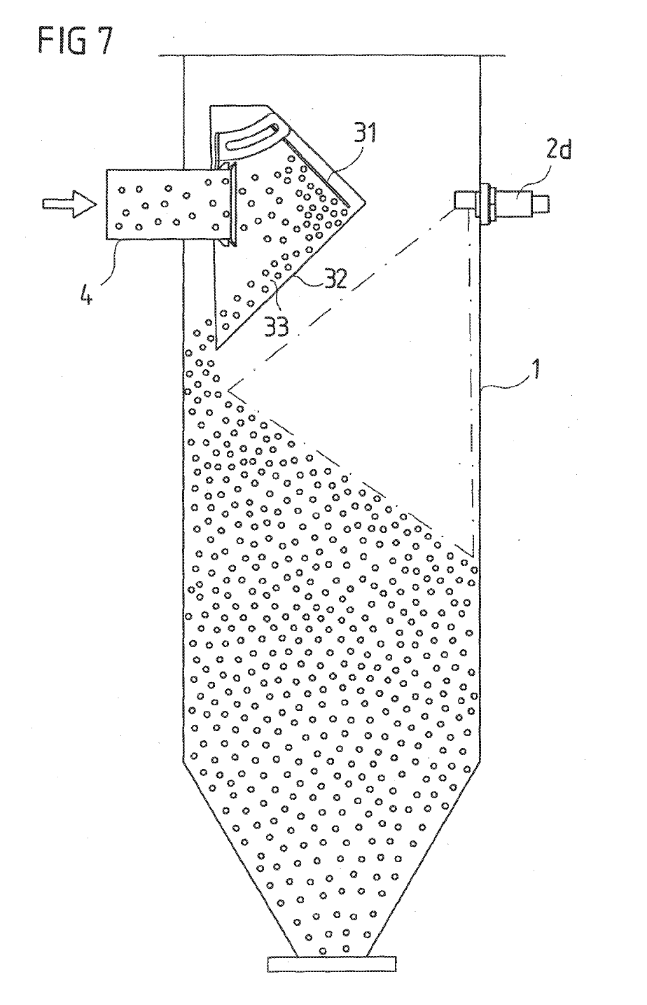

FIG. 7 shows a fifth embodiment with another configuration of the lower conveying region;

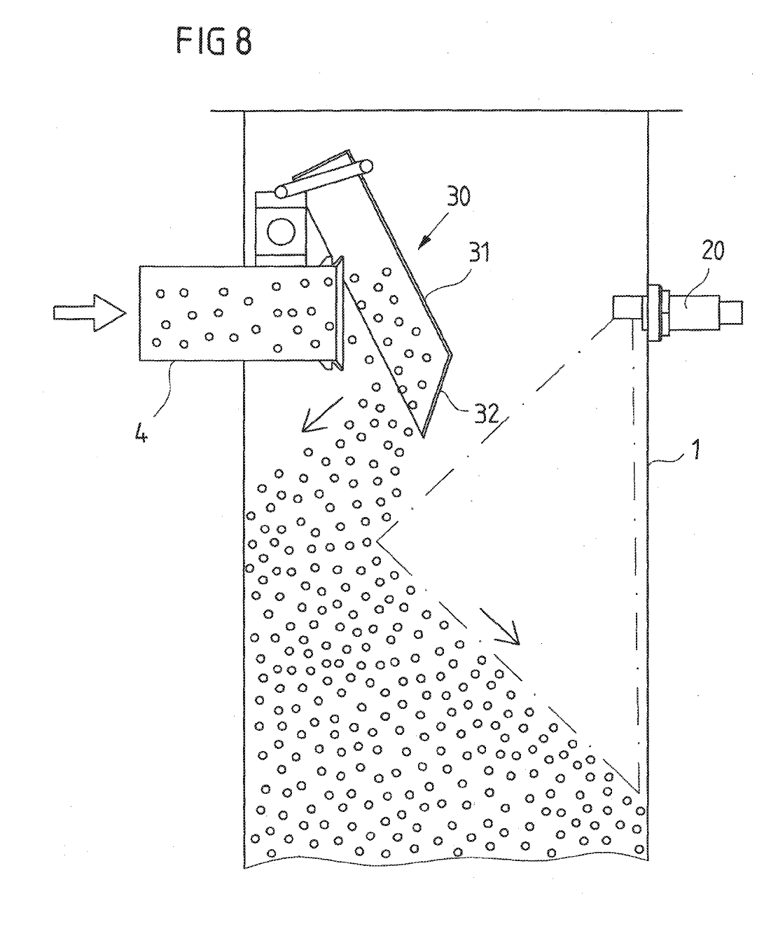

FIG. 8 shows a sixth embodiment with another design of an impact device.

The conventional conveying separator as shown in FIG. 1 comprises a separator 1 (first container) and a recipient tank 7 (second container) arranged directly below the separator 1. Separator 1 and recipient tank 7 are connected with each other via the opening 5.

The bulk material is introduced into the separator through the inlet means 4. Introducing the bulk material in principle is effected by means of suction or pressure conveyance into the separator. According to FIG. 1, the introduction of the bulk material into the separator 1 is effected by means of a pneumatic suction conveyance, wherein the suction flow or suction conveyance flow required therefor is provided by the conveying blower 2. The conveying blower 2 provides the conveying air flow which is introduced into the separator 1 through the open inlet valve 3. Due to the conveying air flow, the bulk material is sucked into the separator 1 through the inlet means 4. In dependence on the filling level of the bulk material in the conveying separator, the conveying air flow can be regulated via the inlet valve 3.

In the conventional embodiment of the conveying separator, the determination of the bulk material quantity in the separator 1 is effected e.g. by means of a capacitive full indicator 9 and/or a capacitive proximity switch 8 provided in the recipient tank. Both the capacitive proximity switch 8 and the capacitive full indicator 9 conventionally are incorporated into the container wall of the separator 1 or the recipient tank 7. Correspondingly, the position of the capacitive measuring means 8, 9 must be fixed already during the construction of the conveying separator according to FIG. 1.

In dependence on the filling level quantity determined by the capacitive switches 8, 9, the mass flow of the bulk material is controlled by the conveying separator. In particular, the control of the mass flow of the bulk material from the separator 1 into the recipient tank 7 is effected by the mechanical actuation of a mechanical pendulum flap 6 provided at the opening 5.

From the recipient tank 7 the bulk material is passed on to a processing machine 10, such as e.g. to an extrusion device.

FIG. 2 shows a first embodiment of the apparatus according to the invention. The construction of the apparatus according to the invention substantially is the same as the construction of a conventional conveying separator as shown in FIG. 1. Both conveying devices of FIG. 1 and FIG. 2 however differ with regard to the employed measuring means for determining the filling level or deficiencies of the bulk material in the separator 1 and recipient tank 7.

In the upper portion of the separator 1, more exactly in the ceiling of the separator 1, a measuring means 20 in the form of an ultrasonic sensor is provided. The ultrasonic transmitter 20 scans the interior space of the separator 1 and hence serves to determine the filling level of the bulk material in the separator 1.

According to the embodiment of FIG. 2, a further ultrasonic sensor 21 likewise is provided in the recipient tank 7, which here likewise is provided in the upper region of the recipient tank 7. The ultrasonic sensor 21 here can be mounted on the outer wall of the frustoconical opening 5, i.e. on the side of the frustoconical opening which points in direction of the recipient tank 7. Correspondingly, the ultrasonic sensors 20, 21 can flexibly be mounted in the conveying device, and their position need not be fixed already during the construction process of the conveying separator.

The ultrasonic sensors 20, 21 each send ultrasonic waves with wavelengths between 50 and 200 kHz into the separator 1 or the recipient tank 7. Due to the specific arrangement of the ultrasonic sensors, the ultrasonic waves are emitted downwards into the separator 1 or recipient tank 7 and reflected by the bulk material present in the separator 1 and recipient tank 7. The sound waves reflected by the bulk material are received by the sensor 20, 21 or a sound transducer connected therewith. From the travel time of the reflected ultrasonic waves the distance between sensor 20, 21 and bulk material and thus the filling level of the bulk material in the separator 1 and recipient tank 7 then is determined.

FIG. 3 shows a second embodiment of the apparatus according to the invention, in which the first and the second container are combined to one single container. This embodiment can be used when the processing machine allows the application of a negative pressure. This is the case in many extrusion processes.

The quantity level measured in a contactless way is used for the determination of the switch-off level 11a, at which e.g. the conveyance is switched off after reaching the full level, the determination of the filling level 11b, e.g. for indication of a required quantity and start of the conveyance, and the determination of an alarm limit 11c, e.g. for monitoring a minimum alarm level.

The filling level of the container is measured by using an ultrasonic sensor. Due to the known container geometry, the filled volume is calculated from the knowledge of the measured filling level. By multiplication with the bulk density, the bulk material quantity is obtained. The bulk density usually is entered in the operating device and/or deposited in a recipe memory.

The use of ultrasonic sensors 20, 21 as compared to the conventionally used capacitive measuring means 8, 9 involves a plurality of advantages, as already described above in detail.

Another advantage consists in that with fluctuating bulk densities the ultrasonic sensor need not be readjusted, as is the case with capacitively operating proximity switches. In the case of strong bulk density fluctuations it can occur that a capacitive probe emits no more signal at all. Previous experiments have revealed that with decreasing bulk density the accuracy of the level measurement decreases, but a sound reflection always takes place. Especially grinding materials thereby can be monitored more reliably.

For a particular controlled introduction of the material stream precautions can be taken such that in particular the sound waves (sound beam) are not traversed by particles flying around. The level measurement hence is not disturbed by contactless measurements, e.g. by means of sound waves, by ultrasonic sensors 20, 21 or the light beam during a laser distance measurement. Corresponding embodiments are shown in FIGS. 4 to 6.

FIG. 4 shows the detection of the material level with quiescent conveyance. At the inlet means 4 a return flap 31 optionally is arranged. The return flap 31 here is formed as pendulum-mounted plate. A guiding means 30, here formed as catch or baffle plate, serves a targeted control of the material stream during the conveyance, which will be illustrated in detail below. The guiding means 30 can include e.g. a perforated plate, so that conveying air can pass through.

FIG. 5 shows the entering material during the conveyance. During inflow, the return flap 31 is opened by the impinging particles and the material gets to the guiding means 30, whose wall 32 here is arranged approximately at right angles to the open return flap 31. In the embodiment shown here the guiding means 31 is formed concave, wherein the wall 32 is part of the concave part. Flowing on the wall 32, the material forms a bulk material cushion 33 which slows down succeeding material. The material slowed down in this way then flows downwards into the separator 1 with a reduced speed, without vortexing much in the separator 1.

FIG. 6 shows a variant of the embodiment according to FIGS. 4 and 5, so that reference can be made to the description. As in FIG. 5, the situation during the suction conveyance is shown here. At the lower end a flap 34 is arranged, which during the suction conveying operation is closed by the applied negative pressure.

Alternatively, FIG. 7 shows an embodiment in which the assembly is effected directly on a machine (not shown here), i.e. without flap 34.

FIG. 8 shows an embodiment in which the return flap 31 and the guiding means 30 are integrated into each other, in that the guiding means 31 is formed in pendulum fashion. For this purpose, the guiding means 30 is formed at least partly concave and is arranged before the inlet means 4. In the rest condition, the concave part of the guiding means 31 lies before the inlet means. In the conveying condition the inflowing material impinges onto the concave part of the guiding means 31, so that the material flows along the wall 32 which is part of the concave part. The function approximately corresponds to the embodiment shown in FIG. 5.

1. An apparatus for the conveyance of at least one flowable material comprising at least one first container for taking up the flowable material, wherein the at least one first container includes at least one first inlet for introducing the flowable material into the first container and at least one outlet for discharging the flowable material from the first container,
wherein
the at least one first container comprises at least one measurer for the contactless measurement of the quantity of the flowable material in the at least one first container, and wherein flowable material entering through the inlet impinges on a guide for forming a bulk material cushion.

2. The apparatus according to claim 1, wherein the first container includes at least one second inlet for introducing at least one air flow for conveying the flowable material into the container.

3. The apparatus according to claim 1, wherein below the first container at least one further second container is arranged, into which the flowable material can be introduced from the first container.

4. The apparatus according to claim 3, wherein the first container and the second container are connected with each other via the at least one outlet for draining the flowable material into the second container.

5. The apparatus according to claim 3, wherein the at least one second container comprises at least one measurer for the contactless measurement of the quantity of the flowable material in the at least one second container.

6. The apparatus according to claim 1, wherein the at least one measurer for the contactless measurement of the quantity of the flowable material in the first and/or second container emits sound waves.

7. The apparatus according to claim 1, wherein the at least one measurer for the contactless measurement of the quantity of the flowable material in the first and/or second container is an ultrasonic sensor, a light sensor, an IR sensor and/or a radar sensor.

8. The apparatus according to claim 1, wherein the at least one measurer for the contactless measurement of the quantity of the flowable material in the first and/or second container each is arranged in an upper region of the first and/or second container, so that the sound waves each impinge from above onto the flowable material present in the first and/or second container.

9. The apparatus according to claim 1, wherein the outlet provided in the lower portion of the first container for discharging the flowable material from the first container into the second container is formed frustoconical.

10. The apparatus according to claim 1, wherein on the outlet a controller is provided for controlling the quantity of flowable material to be introduced from the first container into the second container.

11. The apparatus according to claim 1, wherein the apparatus is connected with a plant for the further processing of the flowable material.

12. The apparatus according to claim 1, wherein flowable material entering through the inlet impinges on a guide which is a wall for forming a bulk material cushion.

13. The apparatus according to claim 12, wherein the guide is coupled with a return flap.

14. A method for conveying at least one flowable material in an apparatus according to claim 1, comprising:
introducing the flowable material via the at least one inlet into the first container, wherein the flowable material entering through the inlet impinges on a guide for forming a bulk material cushion, and
determining the quantity of the flowable material in the first container by using the first measurer provided in the first container for the contactless measurement of the quantity or the filling level of the flowable material in the first container,
wherein in dependence on the quantity of the flowable material determined in the first container the mass flow of the flowable material into or through the first container is controlled.

15. The method according to claim 14, wherein the introduction of the flowable material into the first container through the first inlet can be affected and adjusted by introducing at least one air flow through at least one second inlet.

16. The method according to claim 14, wherein discharging the flowable material from the first container through the outlet is adjusted or controlled by a controller provided at the outlet.

17. The method according to claim 14, wherein the quantity of the flowable material in the second container is determined by using the second measurer provided in the second container for the contactless measurement of the quantity or the filling level of the flowable material in the second container, and that in dependence on the quantity of the flowable material determined in the second container the mass flow of the flowable material out of the second container can be adjusted.

18. The method according to claim 17, wherein the flowable material from the second container is guided to a plant for the further processing of the flowable material.

19. (canceled)

20. An apparatus for conveying at least one flowable material, wherein the apparatus is a conveying separator, and wherein a measurer for contactless measurement of the flowable bulk material in the apparatus is used.

21. The apparatus according to claim 13, wherein the guide is coupled with the return flap as a concave, pendulum-mounted device.
